(19) United States
(12) Patent Application Publication
(10) Pub. No.: US 2019/0118266 A1
(43) Pub. Date: Apr. 25, 2019

(54) CUTTER AND METHOD FOR MACHINING TUBULAR COMPONENT

(71) Applicant: Miasolé Equipment Integration (Fujian) Co., Ltd., Fujian (CN)

(72) Inventors: Minghuang GUO, Fujian (CN); Fuzhong WU, Fujian (CN); Xi'nan HUANG, Fujian (CN); Bangyin LAN, Fujian (CN); Guixian LEI, Fujian (CN); Jindao CHEN, Fujian (CN); Xiutao WANG, Fujian (CN); Ailing CAI, Fujian (CN)

(21) Appl. No.: 16/164,185

(22) Filed: Oct. 18, 2018

(30) Foreign Application Priority Data
Oct. 20, 2017 (CN) 201721358548.9

(51) Int. Cl. B23B 5/16; B23B 5/14

(52) U.S. Cl. CPC B23B 5/168; B23B 2220/28; B23B 5/14

(57) ABSTRACT

The present disclosure provides a cutter and a method for machining a tubular component. The cutter for machining a tubular component comprises a cutter body, a first cutter portion and a second cutter portion being provided on a front end in a longitudinal direction of the cutter body, the first cutter portion extending along the longitudinal direction of the cutter body, and the second cutter portion being located on a rear side of the first cutter portion in the longitudinal direction and protruding from a main side surface of the cutter body in a direction substantially perpendicular to the main side surface.

### CROSS-REFERENCE TO RELATED APPLICATIONS

The present application claims a priority of Chinese patent application No. 2017213585489 filed on Oct. 20, 2017 with State Intellectual Property Office in China, the entirety of which is incorporated herein by reference.

### TECHNICAL FIELD

The present disclosure relates to a technical field of mechanical machining and manufacturing, and particularly relates to a cutter and a method for machining a tubular component.

### BACKGROUND

In the field of mechanical machining, various types of cutters are often used to perform different processings on components; for a tubular component, cutting-off and internal and external chamfering are typically required to be done with different cutters respectively. Since different cutters are generally fixed on a rotatable cutter holder, before machining, the cutter holder must be rotated to turn a desired cutter to be used to a machining position and then a corresponding processing is performed; and when it is desired to change the processing, the cutter holder is rotated again to turn a cutter corresponding to the processing to be performed to the machining position. The existing cutters can only perform a single process, and when the process needs to be switched, the cutter holder must be rotated to change the cutter. Thus, in the case that there are batched components to be processed, this method of switching cutters by rotating the cutter holder will take lots of time and greatly reduce the machining efficiency.

### SUMMARY

An object of the present disclosure is to provide a cutter for machining a tubular component to solve the above technical problem in the prior art, and machining of the tubular component and improvement of the production efficiency can be realized by a single cutter.

According to a first aspect of the disclosure, there is provided a cutter for machining a tubular component, the cutter for machining a tubular component comprises a cutter body, a first cutter portion and a second cutter portion being provided on a front end in a longitudinal direction of the cutter body, the first cutter portion extending along the longitudinal direction of the cutter body, and the second cutter portion is located on a rear side of the first cutter portion in the longitudinal direction and protruding from a main side surface of the cutter body in a direction substantially perpendicular to the main side surface.

According to one aspect of the disclosure, the cutter body, the first cutter portion and the second cutter portion are formed integrally.

According to one aspect of the disclosure, a first cutting edge is provided at an edge of an upper end face of the first cutter portion, a second cutting edge is provided at a rear edge of an upper end face of the second cutter portion, and a preset first angle is formed between the second cutting edge and the main side surface of the cutter body.

According to one aspect of the disclosure, a third cutting edge is provided at a front edge of the upper end face of the second cutter portion.

According to one aspect of the disclosure, the cutter body further comprises a mounting portion and a reinforcing portion, a rear end of the reinforcing portion being fixedly connected to the mounting portion, and a front end of the reinforcing portion being fixedly connected to the first cutter portion, the mounting portion, the reinforcing portion and the first cutter portion sequentially decreasing in thicknesses in the direction substantially perpendicular to the main side surface, and the second cutter portion protruding from the reinforcing portion in the direction substantially perpendicular to the main side surface.

According to one aspect of the disclosure, a mounting hole is provided in the reinforcing portion, and the second cutter portion is detachably mounted into the mounting hole.

According to one aspect of the disclosure, the mounting portion, the reinforcing portion and the first cutter portion are formed integrally.

According to one aspect of the disclosure, the first angle is 30°-60°.

According to one aspect of the disclosure, a preset second angle is formed between the third cutting edge and the main side surface of the cutter body.

According to one aspect of the disclosure, a waste guide groove is provided on each of the first cutter portion and second cutter portion.

According to one aspect of the disclosure, the second angle is 30°-60°.

According to one aspect of the disclosure, a distance from the first cutting edge to the reinforcing portion is greater than a wall thickness of the tubular component.

According to a second aspect of the disclosure, there is provided a method for machining a tubular component using a cutter for machining a tubular component, the cutter comprising a cutter body, a first cutter portion and a second cutter portion being provided on a front end in a longitudinal direction of the cutter body, the first cutter portion extending along the longitudinal direction of the cutter body, and the second cutter portion being located on a rear side of the first cutter portion in the longitudinal direction and protruding from a main side surface of the cutter body in a direction substantially perpendicular to the main side surface, the method comprising: rotating a blank tube of the tubular component, driving the cutter for machining the tubular component so that the second cutter portion is inserted into a hole of the blank tube and the second cutting edge on the second cutter portion contacts an edge of an inner wall of the blank tube to machine an internal chamfer of the blank tube; and retreating the second cutter portion from the hole of the blank tube, and driving the cutter for machining the tubular component again to cause the first cutting edge of the first cutter portion to contact an outer wall of the blank tube to cut off the blank tube.

According to one aspect of the disclosure, the internal chamfer has a preset first angle of 30°-60°.

According to one aspect of the disclosure, the method further comprises driving the cutter for machining the tubular component so that a third cutting edge of the second cutter portion contacts an edge of the outer wall of the blank tube to machine an external chamfer of the blank tube.

According to one aspect of the disclosure, the external chamfer has a preset second angle of 30°-60°.

### BRIEF DESCRIPTION OF THE DRAWINGS

FIG. 1 is a structural schematic view taken at a visual angle of the cutter for machining a tubular component provided in embodiments of the present disclosure;

FIG. 2 is a structural schematic view taken at another visual angle of the cutter for machining a tubular component provided in the embodiments of the present disclosure; and

FIG. 3 is a structural schematic view of a blank tube to be machined into a tubular component.

### REFERENCE NUMERALS

100—cutter body

110—mounting portion

120—reinforcing portion

200—first cutter portion

210—first cutting edge

300—second cutter portion

310—second cutting edge

320—third cutting edge

400—waste guide groove

500—notch

600—blank tube

610—internal chamfer

620—cutting position

a—first angle

b-second angle

### DETAILED DESCRIPTION OF THE PREFERRED EMBODIMENTS

The embodiments of the present disclosure will be described below in detail with examples of the embodiments shown in the drawings throughout which the same or similar reference numerals denote the same or similar components or components with the same or similar functions. The embodiments described below with reference to the drawings are merely illustrative, and are used only for the purpose of explaining the present disclosure and should not be interpreted as limitations to the present disclosure.

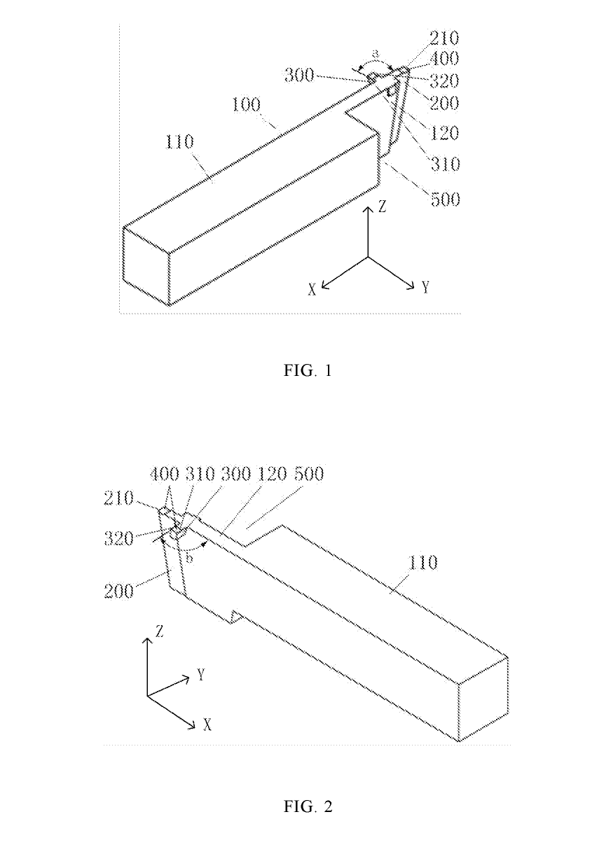

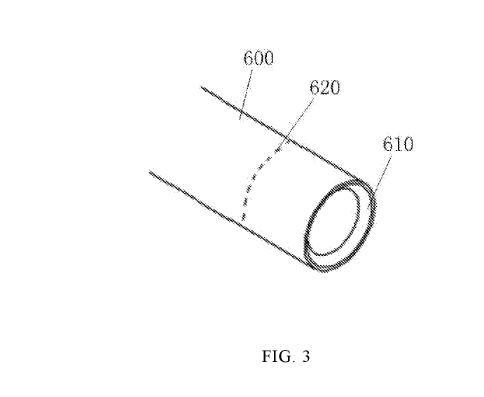

A Cartesian coordinate system is established in FIGS. 1 and 2 to clearly indicate the orientation of various constituent parts of the cutter for machining a tubular component. In the following description of the present disclosure, a direction opposite to the X-axis direction is referred to as a front direction or a front side, and the X-axis direction is referred to as a rear direction or a rear side; a direction opposite to the Y-axis direction is referred to as a left direction or a left side, and the Y-axis direction is referred to as a right direction or a right side; the Z-axis direction is referred to as an up direction or an up side, and a direction opposite to the Z-axis direction is referred to as a down direction or a down side. It shall be noted that the shape and size of respective constituent parts shown in the drawings do not necessarily represent the actual shape and size thereof.

Referring to FIGS. 1-3 together, an embodiment of the present disclosure provides a cutter for machining a tubular component, the cutter comprises an elongated cutter body 100, a first cutter portion 200 and a second cutter portion 300 are provided on a front end in a longitudinal direction of the cutter body 100, the first cutter portion 200 extends along the longitudinal direction of the cutter body 100, and the second cutter portion 300 is located on a rear side of the first cutter portion 200 in the longitudinal direction of the cutter body 100 and protrudes from a main side surface of the cutter body 100 in a direction substantially perpendicular to the main side surface.

As shown in FIG. 2, the longitudinal direction of the cutter body 100 is a direction identical with or opposite to the X-axis direction; the main side surface of the cutter body 100 is a left-side vertical surface of the cutter body 100 when the cutter body 100 is in a machining or operating state, the main side surface is substantially perpendicular to the Y-axis direction and is used as a major surface when the cutter is mounted, fixed and calibrated. As used herein, the term “substantially perpendicular” means a perpendicularity that meets the requirements of manufacturing tolerances and mating precision. For example, when the direction in which the second cutter portion 300 protrudes and the main side surface of the cutter body 100 form an angle within the range of 90±5 degrees, it can be interpreted as “substantially perpendicular”.

In the present embodiment, a first cutting edge 210 is provided at an edge of an upper end face of the first cutter portion 200: a second cutting edge 310 is provided at a rear edge of an upper end face of the second cutter portion 300, and a preset first angle a is formed between the second cutting edge 310 and the main side surface of the cutter body 100. The upper end faces of the first cutter portion 200 and the second cutter portion 300 are upper surfaces facing toward the Z-axis direction of the first cutter portion 200 and the second cutter portion 300.

Since there are various types of tubular components, a shaft sleeve type component is taken as an example in the embodiment for explanation. Before machining and manufacturing of the shaft sleeve, a blank tube 600 to be machined into the shaft sleeve may be secured to a clamping mechanism on an automatic machine tool. Meanwhile, the cutter for machining a tubular component provided in the embodiment of the present disclosure may be secured to a progressive die of the automatic machine tool, and a movement track of the cutter is encoded and input into a control system of the automatic machine tool to realize automatic control of movement of the cutter. During machining, the clamping mechanism drives the blank tube 600 to rotate at a certain speed, and then the progressive die is driven so that the second cutter portion 300 moves with the progressive die to a position corresponding to a hole of the blank tube 600, and then the progressive die is further driven to move towards the blank tube 600 so that the second cutter portion 300 is inserted into the hole of the blank tube 600 and meanwhile, the second cutting edge 310 on the second cutter portion 300 contacts an edge of an inner wall of the hole. Since the blank tube 600 continues rotating towards the second cutting edge 310, a cutting force may be provided for machining the blank tube 600, thus realizing machining of an internal chamfer 610 in the blank tube 600. Further, since a preset first angle α is formed between the second cutting edge 310 and the main side surface of the cutter body 100, the internal chamfer 610 may be machined to a desired angle. In this embodiment, the first angle α formed between the second cutting edge 310 and the main side surface of the cutter body 100 is 30°-60°. In an embodiment, the first angle a is 45°. After machining of the internal chamfer 610 is finished, the progressive die is driven so that the second cutter portion 300 is retreated from the hole, and meanwhile an end of the cutter for machining a tubular component exits along a radial direction of the blank tube 600. Then, the progressive die is further driven so that the cutter for machining a tubular component moves to a cutting-off position 620 along an axial direction of the blank tube 600, as shown in FIG. 3, the first cutting edge 210 of the first cutter portion 200 contacts an outer side wall of the blank tube 600, and at the same time, the progressive die is driven to move towards the blank tube 600 constantly along the radial direction of the blank tube 600, thus realizing gradual cutting-off of the blank tube 600 through continuous self-rotation of the blank tube 600. When the first cutting edge 210 goes through the side wall of the blank tube 600, the blank tube 600 is cut off and the shaft sleeve falls onto a conveying mechanism to be collected, thus completing machining of the shaft sleeve. When cutting of the blank tube 600 is completed, the progressive die returns to an initial position, and meanwhile, the blank tube 600 is re-extended from the clamping mechanism by a certain distance for the machining of a next shaft sleeve.

As discussed above, the present disclosure further provides a method for machining a tubular component using the above discussed cutter for machining a tubular component, the method comprises: rotating a blank tube of the tubular component, driving the cutter for machining the tubular component so that the second cutter portion is inserted into a hole of the blank tube and the second cutting edge on the second cutter portion contacts an edge of an inner wall of the blank tube to machine an internal chamfer of the blank tube; and retreating the second cutter portion from the hole of the blank tube, and driving the cutter for machining the tubular component again to cause the first cutting edge of the first cutter portion to contact an outer wall of the blank tube to cut off the blank tube.

Compared with the prior art, the cutter and the method for machining a tubular component provided in the embodiments of the present disclosure can perform chamfering as well as cutting-off of the shaft sleeve with a single cutter. Meanwhile, the cutter for machining a tubular component always performs a linear feed motion, which realizes continuity in the machining of shaft sleeves, improves the machining efficiency, and solves the problem with low machining efficiency due to the need of rotating the cutter holder to switch cutters in the prior art.

In the present embodiment, a depth by which the second cutter portion 300 is inserted into the blank tube 600 and a depth by which the second cutting edge 310 enters into the side wall of the blank tube 600 may be determined according to the processing requirements on machining the internal chamfer 610, and thus are not limited in the present embodiment.

In an embodiment, a third cutting edge 320 is provided at a front edge of the upper end face of the second cutter portion 300. When machining of the shaft sleeve starts, the third cutting edge 320 may first contact an edge of an end face of the outer wall of the blank tube 600 when driven by the progressive die, and then machining of an external chamfer (no shown) of the blank tube 600 is realized by continuous rotation of the blank tube 600. In this embodiment, a depth by which the third cutting edge 320 contacts with the blank tube 600 may be determined according to the processing requirements on machining the external chamfer. When machining of the external chamfer is finished, the progressive die may cause the second cutter portion 300 to enter into the hole of the blank tube 600 along a preset feed path so as to performing machining of the internal chamfer 610 of the blank tube 600. Thus, by providing the first cutter portion 200 and the second cutter portion 300, and also providing the first cutting edge 210 on the first cutter portion 200, and the second cutting edge 310 and the third cutting edge 320 on the second cutter portion 300, a continuous operation in machining of the external chamfer, the internal chamfer 610 and cutting-off of the blank tube 600 is achieved, thus effectively improving the production efficiency of shaft sleeves.

It should be understood that a second angle b may also be formed between the third cutting edge 320 and the main side surface of the cutter body 100 so that the external chamfer may be machined to a desired angle. In this embodiment, the second angle h formed between the third cutting edge 320 and the main side surface of the cutter body 100 is 30°-60°. In an embodiment, the second angle b is 45°.

It should be noted that a waste guide groove 400 is provided on each of the first and second cutter portions 200, 300. Specifically, the waste guide groove 400 is arc-shaped. During machining, wastes and scraps produced by cutting the blank tube 600 are guided to a position away from a cutting position of a cutting edge through the waste guide groove 400 so as to prevent the wastes and scraps from being accumulated at a position where the cutting edge is located and thus affecting the machining quality.

In an embodiment, the cutter body 100 further includes a mounting portion 110 and a reinforcing portion 120, a rear end of the of the reinforcing portion 120 is fixedly connected to the mounting portion 110, and a front end of the reinforcing portion 120 is fixedly connected to the first cutter portion 200. The mounting portion 110, the reinforcing portion 120 and the first cutter portion 200 sequentially decrease in thicknesses in a direction substantially perpendicular to the main side surface of the cutter body 100, and the second cutter portion 300 protrudes from the reinforcing portion 120 in the direction substantially perpendicular to the main side surface of the cutter body 100. The mounting portion 110 has a greater thickness and thus has a greater fixed area, which ensures stability of the cutter for machining a tubular component secured to the progressive die. Moreover, by securing the second cutter portion 300 substantially perpendicularly on a left side surface of the reinforcing portion 120 (i.e., the main side surface of the cutter body 100), the reinforcing portion 120 can secure the second cutter portion 300 stably without a greater thickness. As a result, the reinforcing portion 120 has a smaller thickness than the mounting portion 110, thus reducing the overall weight of the cutter body 100 so that it is easy to be driven. In addition, since a side face (a left side face) of the reinforcing portion 120 is flush with a side face (a left side face) of the mounting portion 110 and the reinforcing portion 120 has the smaller thickness than the mounting portion 110, a large notch 500 is formed between a side face (a right side face) apart from the second cutting edge 310 of the reinforcing portion 120 and the other side face (a right side face) of the mounting portion 110. Thus, wastes and scraps cut out during machining may fall off through the notch 500, thereby preventing the wastes and scraps from being accumulated at a cutting position of the cutter and affecting the machining quality.

It should be understood that the reinforcing portion 120 having the thickness greater than the cutter portion 200 may increase a securing strength to the first cutter portion 200. Meanwhile, a distance from the first cutting edge 210 to the reinforcing portion 120 is greater than a wall thickness of the tubular component so as to ensure that the blank tube 600 does not interfere with the reinforcing portion 120 during cutting-off of the blank tube 600.

Specifically, both of the first cutter portion 200 and the second cutter portion 300 may be formed integrally with the cutter body 100, but in order to facilitate exchange of the second cutter portion 300 and prevent discard of the overall cutter for machining a tubular component due to damage of a certain cutter portion, the reinforcing portion 120 in the embodiment is provided with a mounting hole (not shown) which has a central axis substantially perpendicular to the left side surface of the reinforcing portion 120 or the main side surface of the cutter body 100, and into which the second cutter portion 300 is detachably mounted. In an embodiment, the second cutter portion 300 is embedded into the mounting hole in an interference fit manner. As used herein, the term “substantially perpendicular” means a perpendicularity that meets the requirements of manufacturing tolerances and mating precision. For example, when the central axis of the mounting hole and the left side surface of the reinforcing portion 120 or the main side surface of the cutter body 100 form an angle within the range of 90+5 degrees, it can be interpreted as “substantially perpendicular”.

It should be understood that in order to facilitate machining of the cutter body 100 and the first cutter portion 200, as well as to ensure machining precision of the first cutter portion 200 and the connection strength between the first cutter portion 200 and the cutter body 100, the mounting portion 110, the reinforcing portion 120 and the first cutter portion 200 may be formed integrally.

The cutter and the method for machining a tubular component provided in the embodiments of the present disclosure can perform internal and external chamfering as well as cutting-off of the shaft sleeve with a single cutter. Meanwhile, the cutter for machining a tubular component always performs a linear feed motion, which realizes continuity in the machining of shaft sleeves, improves the machining efficiency, and solves the problem with low machining efficiency due to the need of rotating the cutter holder to switch cutters in the prior art.

The structure, features, and effects of the present disclosure have been described in detail with reference to the embodiments shown in the drawings. The above embodiments are merely preferred embodiments of the present disclosure, and the scope of the present disclosure is not limited as shown in the drawings. Any change made based on the idea of the present disclosure, or equivalent embodiments that are modified into equivalent variations, should still fall within the protection scope of the present disclosure if they do not go beyond the spirit covered by the description and the drawings.

What is claimed is:

1. A cutter for machining a tubular component, comprising:
a cutter body, a first cutter portion and a second cutter portion being provided on a front end in a longitudinal direction of the cutter body, the first cutter portion extending along the longitudinal direction of the cutter body, and the second cutter portion being located on a rear side of the first cutter portion in the longitudinal direction and protruding from a main side surface of the cutter body in a direction substantially perpendicular to the main side surface.

2. The cutter for machining a tubular component according to claim 1, wherein the cutter body, the first cutter portion and the second cutter portion are formed integrally.

3. The cutter for machining a tubular component according to claim 1, wherein a first cutting edge is provided at an edge of an upper end face of the first cutter portion, a second cutting edge is provided at a rear edge of an upper end face of the second cutter portion, and a preset first angle is formed between the second cutting edge and the main side surface of the cutter body.

4. The cutter for machining a tubular component according to claim 3, wherein a third cutting edge is provided at a front edge of the upper end face of the second cutter portion.

5. The cutter for machining a tubular component according to claim 4, wherein the cutter body further comprises a mounting portion and a reinforcing portion, a rear end of the reinforcing portion being fixedly connected to the mounting portion, a front end of the reinforcing portion being fixedly connected to the first cutter portion, the mounting portion, the reinforcing portion and the first cutter portion sequentially decreasing in thicknesses in the direction substantially perpendicular to the main side surface, and the second cutter portion protruding from the reinforcing portion in the direction substantially perpendicular to the main side surface.

6. The cutter for machining a tubular component according to claim 5, wherein a mounting hole is provided in the reinforcing portion, and the second cutter portion is detachably mounted into the mounting hole.

7. The cutter for machining a tubular component according to claim 5, wherein the mounting portion, the reinforcing portion and the first cutter portion are formed integrally.

8. The cutter for machining a tubular component according to claim 3, wherein the first angle is 30°-60°.

9. The cutter for machining a tubular component according to claim 4, wherein a preset second angle is formed between the third cutting edge and the main side surface of the cutter body.

10. The cutter for machining a tubular component according to claim 1, wherein a waste guide groove is provided on each of the first cutter portion and the second cutter portion.

11. The cutter for machining a tubular component according to claim 9, wherein the second angle is 30°-60°.

12. The cutter for machining a tubular component according to claim 5, wherein a distance from the first cutting edge to the reinforcing portion is greater than a wall thickness of the tubular component.

13. A method for machining a tubular component using a cutter for machining a tubular component, the cutter comprising a cutter body, a first cutter portion and a second cutter portion being provided on a front end in a longitudinal direction of the cutter body, the first cutter portion extending along the longitudinal direction of the cutter body, and the second cutter portion being located on a rear side of the first cutter portion in the longitudinal direction and protruding from a main side surface of the cutter body in a direction substantially perpendicular to the main side surface, the method comprising:
rotating a blank tube of the tubular component, driving the cutter for machining the tubular component so that the second cutter portion is inserted into a hole of the blank tube and the second cutting edge on the second cutter portion contacts an edge of an inner wall of the blank tube to machine an internal chamfer of the blank tube; and
retreating the second cutter portion from the hole of the blank tube, and driving the cutter for machining the tubular component again to cause the first cutting edge of the first cutter portion to contact an outer wall of the blank tube to cut off the blank tube.

14. The method according to claim 13, wherein the internal chamfer has a preset first angle of 30°-60°.

15. The method according to claim 13, further comprising driving the cutter for machining the tubular component so that a third cutting edge of the second cutter portion contacts an edge of the outer wall of the blank tube to machine an external chamfer of the blank tube.

16. The method according to claim 15, wherein the external chamfer has a preset second angle of 30°-60°.
